(19) United States
(12) Patent Application Publication
(10) Pub. No.: US 2025/0308428 A1
(43) Pub. Date: Oct. 2, 2025

(54) DISPLAY DEVICE AND METHOD OF DRIVING DISPLAY DEVICE

(71) Applicant: Samsung Display Co., Ltd., Yongin-Si (KR)

(72) Inventors: Ju Bong AN, Yongin-si (KR); Hyeon Deok JO, Yongin-si (KR)

(21) Appl. No.: 18/895,384

(22) Filed: Sep. 25, 2024

(30) Foreign Application Priority Data
Mar. 27, 2024 (KR) 10-2024-0041726

(51) Int. Cl. G09G 3/20; G09G 3/32

(52) U.S. Cl. CPC G09G 3/2007; G09G 3/32; G09G 2300/0819; G09G 2300/0842; G09G 2300/0861; G09G 2320/0233; G09G 2320/0242; G09G 2320/0276; G09G 2320/041; G09G 2330/028; G09G 2360/14

(57) ABSTRACT

A display device includes a display unit including a plurality of pixels, a power supply configured to generate a plurality of driving voltages, a current sensor configured to sense a current amount output from the power supply to the display unit while reference image data is displayed on the display unit and generate a sensing current value corresponding to a sensing result, and a driver configured to generate a data signal and transmit the data signal to the pixel. The driver generates the data signal by applying an offset determined for each grayscale of image data input based on the sensing current value.

This application claims priority to Korean Patent Application No. 10-2024-0041726, filed on Mar. 27, 2024, and all the benefits accruing therefrom under 35 U.S.C. § 119, the content of which in its entirety is herein incorporated by reference.

### BACKGROUND

### 1. Field

An embodiment of the disclosure relates to a display device and a method of driving the display device.

### 2. Description of the Related Art

As information technology develops, importance of a display device, which is a connection medium between a user and information, is emerging. In response to this, a use of the display device such as a liquid crystal display device and an organic light emitting display device is increasing.

When an environment in which the display device is driven, for example, a temperature and an illuminance around the display device changes, a driving voltage required for driving the display device may change to respond to an environment change. In this case, a luminance ratio for each grayscale or a luminance change degree for each color of image data displayed on the display device may be different, and thus image quality may be deteriorated.

### SUMMARY

An embodiment of the disclosure provides a display device capable of minimizing a luminance change and a color distortion phenomenon in a low grayscale when an external environment changes.

An embodiment of the disclosure provides a method of driving a display device capable of minimizing a luminance change and a color distortion phenomenon in a low grayscale when an external environment changes.

According to embodiments of the disclosure, a display device includes a display unit including a plurality of pixels, a power supply configured to generate a plurality of driving voltages, a current sensor configured to sense a current amount output from the power supply to the display unit while reference image data is displayed on the display unit and generate a sensing current value corresponding to a sensing result, and a driver configured to generate a data signal and transmit the data signal to a corresponding pixel. The driver generates the data signal by applying an offset determined for each grayscale of image data input based on the sensing current value.

In an embodiment, the display device may further include a memory configured to store a reference current value, a plurality of offset lookup tables, and a gamma lookup table. The reference current value corresponds to the current amount output from the power supply to the display unit while reference image data determined in advance at a reference temperature is displayed on the display unit. The driver compares the reference current value and the sensing current value, selects one of the plurality of offset lookup tables based on a comparison result, and corrects the gamma lookup table using the selected offset lookup table.

In an embodiment, the driver may include a controller configured to convert input image data to generate image data, a data converter configured to receive the sensing current value, the reference current value, the image data, and the gamma lookup table, and generate a voltage value corresponding to the image data, and a data driver connected to the pixel through a data line, and configured to generate the data signal corresponding to the voltage value and supply the generated data signal to the data line.

In an embodiment, the data converter may include a first converter corresponding to red, a second converter corresponding to green, and a third converter corresponding to blue. The gamma lookup table may include at least one of a first gamma lookup table corresponding to red, a second gamma lookup table corresponding to green, and a third gamma lookup table corresponding to blue.

In an embodiment, the first converter may include a comparator configured to receive the reference current value and the sensing current value and output a difference value corresponding to a difference between the reference current value and the sensing current value, a first offset determiner configured to receive an offset lookup table corresponding to the difference value from the memory, and a first voltage value generator configured to receive the first gamma lookup table, correct at least one entry value included in the first gamma lookup table based on the offset lookup table, generate a corrected first gamma lookup table, and generate a voltage value corresponding to the image data using the corrected first gamma lookup table.

In an embodiment, the first voltage value generator may correct an entry value of which a gray value is less than a reference value using the offset lookup table among entry values included in the first gamma lookup table, and maintain an entry value of which the gray value is greater than or equal to the reference value among the entry values included in the first gamma lookup table.

In an embodiment, the first converter may include a comparator configured to receive the reference current value and the sensing current value and output a difference value corresponding to a difference between the reference current value and the sensing current value, a first offset determiner configured to receive an offset lookup table corresponding to the difference value from the memory, a first data adjuster configured to generate adjusted image data by adjusting a value of the image data based on the offset lookup table, and a first voltage value generator configured to generate a voltage value corresponding to the adjusted image data using the first gamma lookup table.

In an embodiment, the first data adjuster may correct a value of the image data using the offset lookup table when the value of the image data is less than a reference value, and maintains the value of the image data when the value of the image data is greater than or equal to the reference value.

In an embodiment, the display device may further include a temperature sensor configured to sense a temperature and generate a power control signal corresponding to the sensed temperature. The power supply may change a voltage level of the driving voltage based on the power control signal.

In an embodiment, the display device may further include an illuminance sensor configured to sense an illuminance and generate a power control signal corresponding to the sensed illuminance. The power supply may change a voltage level of the driving voltage based on the power control signal.

By a method of operating a display device according to an embodiment of the disclosure, an operation current of a display panel is sensed while displaying a reference pattern on the display panel, the sensed operation current is compared with a predetermined reference current value, one of a plurality of offset lookup tables is selected according to the comparing result, a gamma lookup table is corrected using the selected offset lookup table, and a voltage value corresponding to image data is generated using the corrected gamma lookup table.

In an embodiment, the selecting one of the plurality of offset lookup tables may include selecting a first offset lookup table corresponding to red, selecting a second offset lookup table corresponding to green, and selecting a third offset lookup table corresponding to blue.

In an embodiment, the correcting the gamma lookup table may include correcting a first gamma lookup table corresponding to red using the first offset lookup table, correcting a second gamma lookup table corresponding to green using the second offset lookup table, and correcting a third gamma lookup table corresponding to blue using the third offset lookup table.

In an embodiment, when correcting the first gamma lookup table corresponding to red, an entry of which a gray value is less than a predetermined reference value among entries of the first gamma lookup table may be corrected using an offset value included in the first offset lookup table, and an entry of which the gray value is greater than or equal to the reference value among the entries of the first gamma lookup table may be maintained.

In an embodiment, the method may further include displaying an image on the display panel using the generated voltage value, after generating the voltage value corresponding to the image data.

In an embodiment, the method may further include sensing the operation current of the display panel while displaying the reference pattern on the display panel under a reference environment, and storing a reference current value corresponding to the sensed operation current in a memory, before sensing the operation current of the display panel while displaying the reference pattern on the display panel.

By a method of operating a display device according to an embodiment of the disclosure, an operation current of a display panel is sensed while displaying a reference pattern on the display panel, the sensed operation current is compared with a predetermined reference current value, one of a plurality of offset lookup tables is selected according to the comparing result, adjusted image data from image data is generated using the selected offset lookup table, and a voltage value corresponding to the adjusted image data is generated using a gamma lookup table.

In an embodiment, the selecting one of the plurality of offset lookup tables may include selecting a first offset lookup table corresponding to red, selecting a second offset lookup table corresponding to green, and selecting a third offset lookup table corresponding to blue.

In an embodiment, the generating adjusted image data from the image data may include adjusting first image data corresponding to red using the first offset lookup table, adjusting image data corresponding to green using the second offset lookup table, and adjusting third image data corresponding to blue using the third offset lookup table.

In an embodiment, when adjusting the first image data corresponding to red, a value of the first image data may be adjusted using an offset value included in the first offset lookup table when the value of the first image data is less than a predetermined reference value, and the value of the first image data may be maintained when the value of the first image data is greater than or equal to the predetermined reference value.

In accordance with a display device and a method of driving the display device, a luminance change and a color distortion phenomenon may be minimized in a low grayscale when an external environment changes.

### BRIEF DESCRIPTION OF THE DRAWINGS

The above and other features of the disclosure will become more apparent by describing in further detail embodiments thereof with reference to the accompanying drawings, in which:

FIG. 1 is a block diagram illustrating a display device according to an embodiment of the disclosure;

FIG. 2 is a diagram illustrating an example of a pixel included in the display device of FIG. 1;

FIGS. 3A, 3B, 3C and 3D are graphs illustrating a luminance change for each temperature of white, red, green, and blue light, respectively;

FIG. 4 is a block diagram illustrating a display device according to an embodiment of the disclosure;

FIG. 5 is a block diagram illustrating an embodiment of a data converter 132′ of FIG. 4;

FIG. 6 is a block diagram illustrating an embodiment of a first converter 210 shown in FIG. 5;

FIGS. 7A and 7B are diagrams illustrating a method of correcting a first gamma lookup table GLUT1 by a first voltage value generator shown in FIG. 6;

FIG. 8 is a graph illustrating a luminance change for each temperature of white light when the display device 101 according to the embodiment of FIG. 4 displays an image;

FIG. 9 is a flowchart illustrating a method of operating a display device according to an embodiment of the disclosure;

FIG. 10 is a flowchart illustrating a method of operating a display device according to still an embodiment of the disclosure;

FIG. 11 is a block diagram illustrating an embodiment of the first converter shown in FIG. 5; and

FIG. 12 is a flowchart illustrating a method of operating a display device according to further still an embodiment of the disclosure.

### DETAILED DESCRIPTION OF THE EMBODIMENT

The disclosure may be modified in various manners and have various forms. Therefore, specific embodiments will be illustrated in the drawings and will be described in detail in the specification. However, it should be understood that the disclosure is not intended to be limited to the disclosed specific forms, and the disclosure includes all modifications, equivalents, and substitutions within the spirit and technical scope of the disclosure.

Terms of “first”, “second”, and the like may be used to describe various components, but the components should not be limited by the terms. The terms are used only for the purpose of distinguishing one component from an component. For example, without departing from the scope of the disclosure, a first component may be referred to as a second component, and similarly, a second component may also be referred to as a first component. In the following description, the singular expressions include plural expressions unless the context clearly dictates otherwise.

It should be understood that in the present application, a term of “include”, “have”, or the like is used to specify that there is a feature, a number, a step, an operation, a component, a part, or a combination thereof described in the specification, but does not exclude a possibility of the presence or addition of one or more other features, numbers, steps, operations, components, parts, or combinations thereof in advance.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the inventive concept. In addition, in some embodiments, the block, unit and/or module may be physically combined into more complex blocks, units, and/or modules without departing from the scope of the inventive concept.

Hereinafter, a display device according to an embodiment of the disclosure is described with reference to drawings related to embodiments of the disclosure.

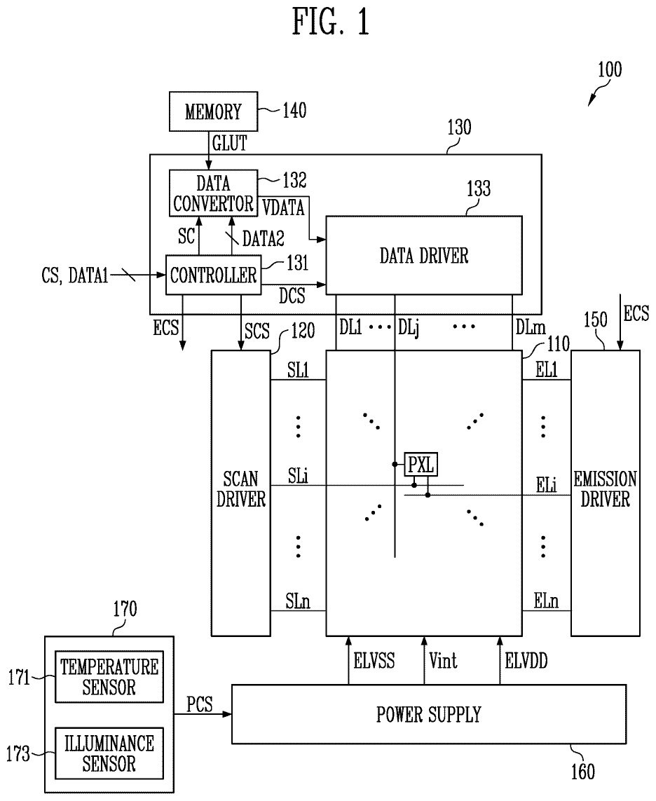

FIG. 1 is a block diagram illustrating a display device according to an embodiment of the disclosure.

Referring to FIG. 1, the display device 100 may include a display unit 110 (or a display panel), a scan driver 120, a driver 130, a memory 140 (or a storage unit), an emission driver 150, a power supply 160, and a sensing unit 170.

The display unit 110 may include scan lines SL1 to SLn (where n is a positive integer), data lines DL1 to DLm (where m is a positive integer), emission control lines EL1 to ELn, and a plurality of pixels PXL. The plurality of pixels PXL may be disposed in an area partitioned by the scan lines SL1 to SLn, the data lines DL1 to DLm, and the emission control lines EL1 to ELn.

Each of the plurality of pixels PXL may be connected to at least one of the scan lines SL1 to SLn, one of the data lines DL1 to DLm, and one of the emission control lines EL1 to ELn. For example, a pixel PXL positioned in an i-th row and a j-th column may be connected to an i-th scan line SLi, a j-th data line DLj, and an i-th emission control line ELi (where, each of i and j is a positive integer).

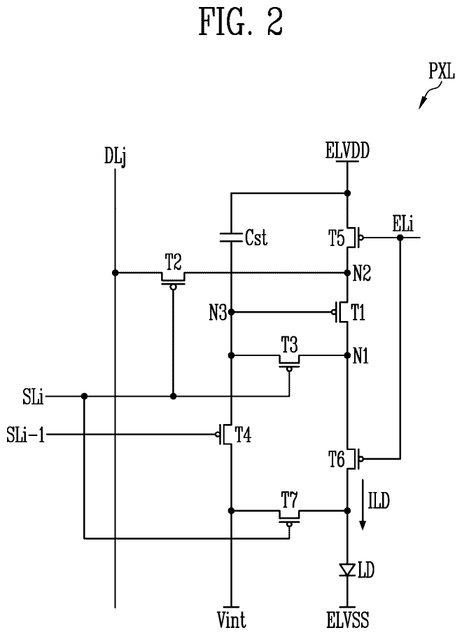

The pixel PXL may store a data signal (or a data voltage) provided through the j-th data line DLj in response to a scan signal provided through the i-th scan line SLi, and may emit light with a luminance corresponding to the stored data signal in response to an emission control signal provided through the i-th emission control line ELi. The pixel PXL is described later with reference to FIG. 2.

The scan driver 120 may generate the scan signal based on a scan control signal SCS and sequentially provide the scan signal to the scan lines SL1 to SLn. Here, the scan control signal SCS may include a start signal, clock signals, and the like, and may be provided from the driver 130. The scan driver 120 may include a shift register that sequentially outputs the scan signal in response to the start signal of a pulse form using the clock signals.

The scan driver 120 may be formed in the display unit 110 through the same process as a process of forming the pixel PXL, or may be implemented as a separate integrated circuit.

The emission driver 150 may generate the emission signal based on an emission control signal ECS and provide the emission signal to the emission control lines EL1 to ELn sequentially or simultaneously. Here, the emission drive control signal ECS may include an emission start signal, emission clock signals, and the like, and may be provided from the driver 130. The emission driver 150 may include a shift register that sequentially outputs the emission signal in response to the emission start signal of a pulse form using the emission clock signals.

The driver 130 may generate data signals based on input image data DATA1 and a control signal CS provided from an outside (for example, a graphics processor).

The driver 130 may include a controller 131 (or a timing controller), a data converter 132, and a data driver 133. The controller 131, the data converter 132, and the data driver 133 may be implemented in one integrated circuit. However, this is an example and the configuration of the driver is not limited thereto. For example, the controller 131 may be implemented as an integrated circuit by including the data converter 132, and the data driver 133 may be implemented as an integrated circuit independent from the controller 131.

The controller 131 may receive the input image data DATA1 and the control signal CS from the outside, generate the scan control signal SCS and the data control signal DCS based on the control signal CS, and generate an image data DATA2 by converting the input image data DATA1. Here, the control signal CS may include a vertical synchronization signal, a horizontal synchronization signal, a clock, and the like. For example, the controller 131 may convert the input image data DATA1 of an RGB format into the image data DATA2 of an RGBG format that matches a pixel arrangement in the display unit 110.

The data converter 132 may convert an input grayscale value included in the image data DATA2 into a voltage value VDATA using a gamma lookup table GLUT. Here, the gamma lookup table GLUT may include the voltage value VDATA corresponding to the input grayscale value, and the gamma lookup table GLUT may be provided from the memory 140 to the data converter 132. The voltage value VDATA may include information on a gamma voltage corresponding to the image data DATA2, and for example, the voltage value VDATA may be a data value of a voltage domain. For example, a relationship between the grayscale value of the image data DATA2 and the voltage value VDATA may correspond to or coincide with a 2.2 gamma curve.

The data driver 133 may generate data signals based on the data control signal DCS provided from the controller 131 and the voltage value VDATA provided from the data converter 132, and provide the data signals to the display unit 110 (or the plurality of pixels PXL). Here, the data control signal DCS may be a signal that controls an operation of the data driver 133, and may include a load signal (or a data enable signal) that directs an output of a valid data signal.

For example, the data driver 133 may include a shift register, a latch, a decoder, an output buffer, and the like, and the data driver 133 may sequentially provide or temporarily store the voltage value VDATA in the shift register or the latch based on the data control signal DCS and output the gamma voltage corresponding to the voltage value VDATA to the data line through the decoder.

The memory 140 may store the gamma lookup table GLUT. For example, the memory 140 may be implemented as a flash memory, may be mounted on a flexible circuit board on which the driver 130 is mounted, and may be connected to the driver 130 (for example, the data converter 132).

The power supply 160 may supply first and second power voltages ELVDD and ELVSS to the display unit 110. Here, the first and second power voltages ELVDD and ELVSS may be voltages required for an operation of the plurality of pixels PXL, and the first power voltage ELVDD may have a voltage level higher than a voltage level of the second power voltage ELVSS. In addition, an initialization power voltage Vint may be provided to the display unit 110 from the power supply 160. The initialization power voltage Vint may be provided to the display unit 110 from the power supply 160 through the driver 130 (for example, the data driver 133). In FIG. 1, only the first and second power voltages ELVDD and ELVSS and the initialization voltage Vint are shown as examples, but the power supply 160 may further generate other voltages for driving the display device 100.

The sensing unit 170 may include at least one sensor. For example, the sensing unit 170 may include a temperature sensor 171 and an illumination sensor 173. The sensing unit 170 may generate a power control signal PCS based on temperature information sensed by the temperature sensor 171 and illuminance information sensed by the illuminance sensor 173. The power control signal PCS may be transmitted to the power supply 160. The power supply 160 may adjust a level of the generated voltage, based on the power control signal PCS. For example, the power supply 160 may adjust a level of at least one of the first and second power voltages ELVDD and ELVSS and the initialization voltage Vint.

For example, when the temperature sensed by the temperature sensor 171 increases, the sensing unit 170 may generate the power control signal PCS for increasing the second power voltage ELVSS. Meanwhile, when the illuminance sensed by the illuminance sensor 173 increases, the sensing unit 170 may generate the power control signal PCS for decreasing the second power voltage ELVSS. For example, the sensing unit 170 may generate the power control signal PCS for controlling the second power voltage ELVSS based on a combination of the sensed temperature and the sensed illuminance. In this case, a lookup table for determining the second power voltage ELVSS according to the combination of the sensed temperature and the sensed illuminance may be used. Although not shown in FIG. 1, the memory 140 may store such a lookup table.

As an example, when the temperature sensed by the temperature sensor 171 increases, the sensing unit 170 may generate the power control signal PCS for decreasing the initialization voltage Vint. In addition, even though the illuminance sensed by the illuminance sensor 173 changes, the sensing unit 170 may not generate the power control signal PCS for changing the initialization voltage Vint. The sensing unit 170 may generate the power control signal PCS for controlling the initialization voltage Vint based on the sensed temperature regardless of the sensed illuminance.

FIG. 2 is a diagram illustrating an example of the pixel included in the display device of FIG. 1.

Referring to FIG. 2, the pixel PXL may include first to seventh transistors T1 through T7, a storage capacitor Cst, and a light emitting element LD.

Each of the first to seventh transistors T1 to T7 may be implemented as a P-type transistor, but the configuration of each of the first to seventh transistors T1 to T7 is not limited thereto. For example, at least a portion of the first to seventh transistors T1 to T7 may be implemented as an N-type transistor.

A first electrode of the first transistor T1 (or a driving transistor) may be connected to a second node N2 or may be connected to a first power line (that is, a power line to which the first power voltage ELVDD is applied) through the fifth transistor T5. A second electrode of the first transistor T1 may be connected to a first node N1 or may be connected to an anode of the light emitting element LD through the sixth transistor T6. A gate electrode of the first transistor T1 may be connected to a third node N3. The first transistor T1 may control an amount of a current flowing from the first power line to a second power line (that is, a power line for transferring the second power voltage ELVSS) through the light emitting element LD in correspondence with a voltage of the third node N3.

The second transistor T2 (or a switching transistor) may be connected between the j-th data line DLj and the second node N2. A gate electrode of the second transistor T2 may be connected to the i-th scan line SLi. The second transistor T2 may be turned on when the scan signal is supplied to the i-th scan line SLi to electrically connect the j-th data line DLj and the first electrode of the first transistor T1 to each other.

The third transistor T3 may be connected between the first node N1 and the third node N3. A gate electrode of the third transistor T3 may be connected to the i-th scan line SLi. The third transistor T3 may be turned on when the scan signal is supplied from the i-th scan line SLi to electrically connect the first node N1 and the third node N3 to each other. Therefore, when the third transistor T3 is turned on, the first transistor T1 may be diode connected.

The storage capacitor Cst may be connected between the first power line and the third node N3. The storage capacitor Cst may store a voltage corresponding to the data signal and a threshold voltage of the first transistor T1.

The fourth transistor T4 may be connected between the third node N3 and an initialization power line (that is, a power line for transferring the initialization power voltage Vint). A gate electrode of the fourth transistor T4 may be connected to an (i-1)-th scan line SLi-1 (or a previous scan line). The fourth transistor T4 may be turned on when the scan signal is supplied from the (i-1)-th scan line SLi-1 to supply the initialization power voltage Vint to the third node N3. Here, the initialization power voltage Vint may be set to have a voltage level lower than that of the data signal.

The fifth transistor T5 may be connected between the first power line and the second node N2. A gate electrode of the fifth transistor T5 may be connected to the i-th emission control line ELi. The fifth transistor T5 may be turned off when the emission control signal is supplied from the i-th emission control line ELi, and may be turned on in other cases.

The sixth transistor T6 may be connected between the first node N1 and the light emitting element LD. A gate electrode of the sixth transistor T6 may be connected to the i-th emission control line ELi. The sixth transistor T6 may be turned off when the emission control signal is supplied from the i-th emission control line ELi, and may be turned on in other cases.

The seventh transistor T7 may be connected between the initialization power line and the anode of the light emitting element LD. A gate electrode of the seventh transistor T7 may be connected to the i-th scan line SLi. The seventh transistor T7 may be turned on when the scan signal is supplied from the i-th scan line SLi to provide the initialization power voltage Vint to the anode of the light emitting element LD.

The anode of the light emitting element LD may be connected to the first transistor T1 through the sixth transistor T6 and a cathode of the light emitting element LD may be connected to the second power line. The light emitting element LD may generate light of a predetermined luminance corresponding to the current supplied from the first transistor T1. The first power voltage ELVDD may be set to have a voltage level higher than the second power voltage ELVSS so that a current ILD flows to the light emitting element LD.

As described above, when the temperature and the illuminance sensed by the sensing unit 170 change, the second power voltage ELVSS or the initialization voltage Vint supplied to the pixel PXL may be adjusted.

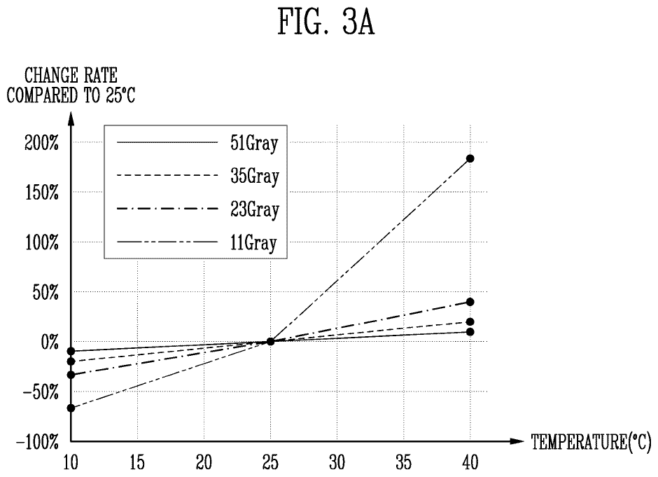

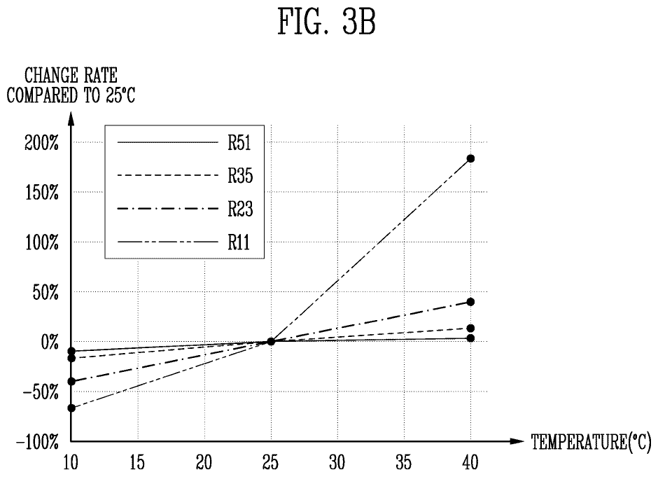

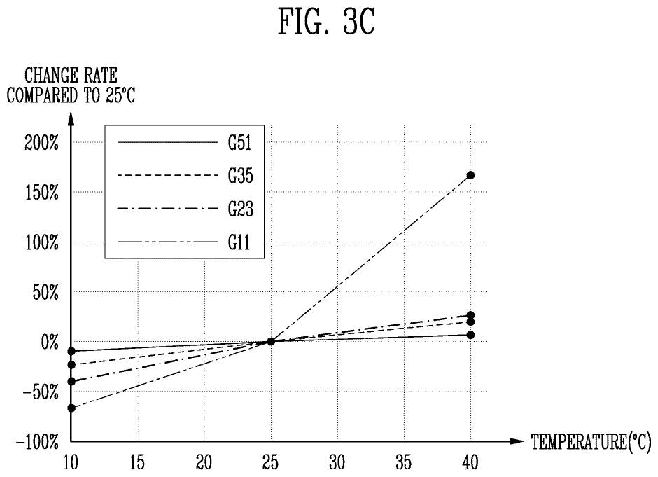

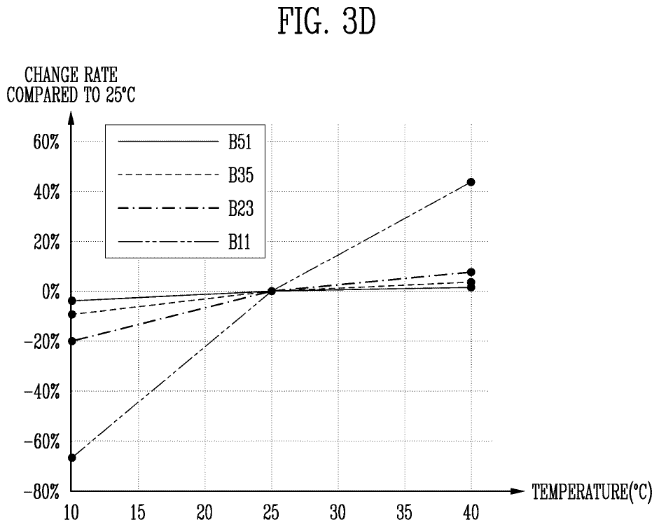

FIGS. 3A to 3D are graphs illustrating a luminance change rate for white, red, green, and blue light according to temperature. FIG. 3A is a graph illustrating the luminance change rate of a white light for each of four grayscale data according to a temperature change. The luminance change rate is a value dividing luminance at a certain temperature by luminance at a room temperature, for example, 25° C. FIG. 3B is a graph illustrating the luminance change rate of a red light for each of four grayscale data according to the temperature change. FIG. 3C is a graph illustrating the luminance change rate of the green light for each of the four grayscale data according to the temperature change. FIG. 3D is a graph illustrating the luminance change rate of the blue light for each of four grayscale data according to the temperature change.

Referring to FIG. 3A, a graph in which a white light luminance of 11 Gray, 23 Gray, 35 Gray, and 51 Gray among grayscales ranging from 0 to 255 gray changes according to the temperature change is shown. As described above, as the temperature changes, the second power voltage ELVSS and the initialization voltage Vint may be adjusted.

When the display unit 110 of the display device 100 displays white image data corresponding to 11 Gray, a luminance of the display unit 110 decreases by 71% at 10° C. and increases by 179% at 40° C. as compared to luminance at 25° C.

When the display unit 110 of the display device 100 displays white image data

corresponding to 23 Gray, the luminance of the display unit 110 decreases by 35% at 10° C. and increases by 43% at 40° C. as compared to the luminance at 25° C.

When the display unit 110 of the display device 100 displays white image data corresponding to 35 Gray, the luminance of the display unit 110 decreases by 16% at 10° C. and increases by 13% at 40° C. as compared to the luminance at 25° C.

When the display unit 110 of the display device 100 displays white image data corresponding to 51 Gray, the luminance of the display unit 110 decreases by 9% at 10° C. and increases by 3% at 40° C. as compared to the luminance at 25° C.

That is, when grayscales of the white image data displayed by the display unit 110 are different, the luminance change rates for each grayscale according to the temperature change may be different. Therefore, a luminance difference is required to be corrected for each grayscale range.

Referring to FIG. 3B, a graph in which a red light luminance of 11R, 23R, 35R, and 51R among red grayscales ranging from 0 to 255R changes according to the temperature change is shown.

When the display unit 110 of the display device 100 displays red image data corresponding to 11R, the luminance of the display unit 110 decreases by 73% at 10° C. and increases by 177% at 40° C. as compared to the luminance at 25° C.

When the display unit 110 of the display device 100 displays white image data corresponding to 23R, the luminance of the display unit 110 decreases by 41% at 10° C. and increases by 45% at 40° C. as compared to the luminance at 25° C.

When the display unit 110 of the display device 100 displays white image data corresponding to 35R, the luminance of the display unit 110 decreases by 14% at 10° C. and increases by 11% at 40° C. as compared to the luminance at 25° C.

When the display unit 110 of the display device 100 displays white image data corresponding to 51R, the luminance of the display unit 110 decreases by 8% at 10° C. and increases by 2% at 40° C. as compared to the luminance at 25° C.

That is, when grayscales of red image data displayed by the display unit 110 are different, the luminance change rates for each grayscale according to the temperature change may be different. Referring to FIGS. 3C and 3D together, it may be seen that when grayscales of green and blue image data displayed by the display unit 110 are different, it may be seen that the luminance change rates for each grayscale according to the temperature change may be different.

Meanwhile, referring to FIGS. 3B to 3D, it may be seen that luminance change

rates of the red, green, and blue image data are different from each other as the same temperature changes. Therefore, that is, the luminance difference is required to be corrected for each color according to the temperature change.

Meanwhile, referring to all of FIGS. 3A to 3D, regardless of a color of an image displayed by the display unit 110, when a grayscale value is large, the luminance change rate according to the temperature change decreases. In particular, when the grayscale is equal to or higher than 51, the luminance change rate according to the temperature change becomes small enough to be ignored.

Referring to FIGS. 1 and 2 together, in a case of the display device 100 shown in FIG. 1, when a voltage supplied to each pixel is uniformly changed according to the temperature and the illuminance, an effect of the adjusted voltage on the pixel representing different colors becomes different. For example, even when a change amount of the second power voltage ELVSS supplied to each pixel is the same as shown in FIGS. 3B to 3D, a luminance of light emitted from a red pixel, a luminance of light emitted from a green pixel, and a luminance of light emitted from a blue pixel may be different. Accordingly, color distortion of the image displayed by the display device 100 may occur.

In addition, as may be seen in the graph of each of FIGS. 3A to 3D, a luminance change amount of each pixel according to the temperature change may be different for each grayscale range of image data. Therefore, as described with reference to FIGS. 1 and 2, when a voltage supplied to each pixel changes according to the temperature and the illuminance, properly compensating for a luminance change according to the grayscale range of the image data is difficult.

A display device according to an embodiment of the disclosure, the power supply 160 senses a current supplied to the display unit 150. When the current supplied to the display unit 150 changes as the voltage supplied by the power supply 160 changes, the gamma lookup table GLUT is altered for each color based on a changed current difference. Accordingly, even though the voltage supplied from the power supply 160 is adjusted according to the temperature and illuminance change, quality of the image displayed by the display unit 110 of the display device 100 may be maintained.

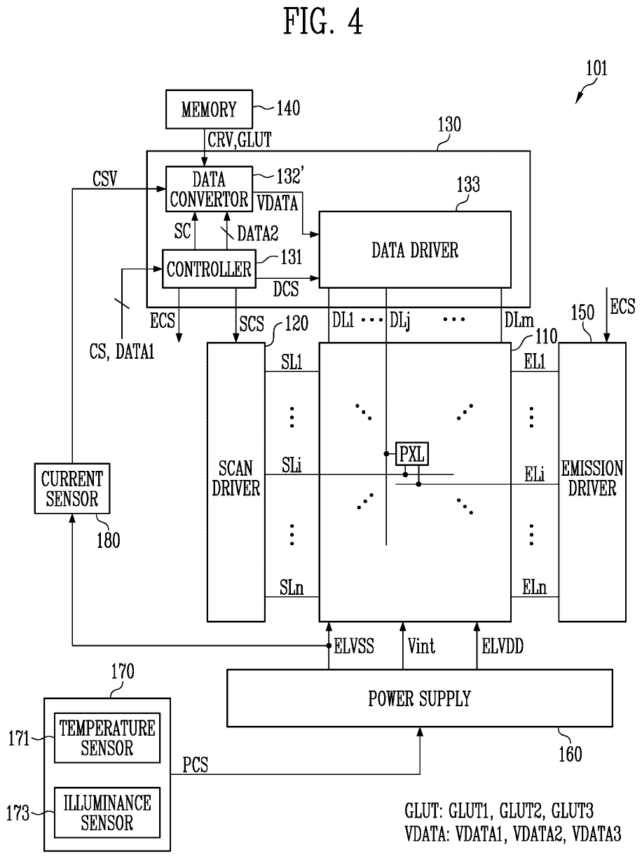

FIG. 4 is a block diagram illustrating a display device according to an embodiment of the disclosure. The display device 101 of FIG. 4 is substantially the same as the display device 100 of FIG. 1 except that the display device 101 of FIG. 4 further includes a current sensor 180. Therefore, a description overlapping that of FIG. 1 is omitted.

Referring to FIG. 4, the current sensor 180 may sense a current through a terminal or a line through which the second power voltage ELVSS is supplied from the power supply 160 to the display unit 110. As described above with reference to FIG. 2, the current ILD flows via the light emitting element LD of each pixel PXL to the second power voltage ELVSS from the first power voltage ELVDD. Therefore, the current sensor 180 may sense a current amount flowing through the light emitting elements LD of all pixels included in the display unit 110 through the terminal or the line to which the second power voltage ELVSS is supplied from the power supply 160.

The current sensor 180 may sense the current through the terminal or the line to which the second power voltage ELVSS is supplied, generate a sensing current value CSV corresponding thereto, and transmits the generated sensing current value CSV to a data converter 132′.

The data converter 132′ may receive a reference current value CRV and the gamma lookup table GLUT from the memory 140. The reference current value CRV may be a value corresponding to the current amount sensed by the current sensor 180 when predetermined reference image data is displayed on the display unit 110 at a reference temperature, for example, 25° C. The reference current value CRV may be stored in the memory 140 in a test step of the display device 101.

The gamma lookup table GLUT stored in the memory 140 may include first to third gamma lookup tables GLUT1 to GLUT3. The first to third gamma lookup tables GLUT1 to GLUT3 may be gamma lookup tables for different colors. For example, the first gamma lookup table GLUT1 may correspond to image data for driving the red pixel. In addition, the second gamma lookup table GLUT2 may correspond to image data for driving the green pixel. Meanwhile, the third gamma lookup table GLUT3 may correspond to image data for driving the blue pixel.

The data converter 132′ may adjust the gamma lookup table GLUT by comparing the sensing current value CSV with the reference current value CRV.

Specifically, the data converter 132′ may select an offset lookup table by comparing the sensing current value CSV with the reference current value CRV, and respectively apply offsets included in the offset lookup table to the first to third gamma lookup tables GLUT1 to GLUT3 to correct the first to third gamma lookup tables GLUT1 to GLUT3. In addition, the data converter 132′ may generate the voltage value VDATA from the image data DATA2 based on the corrected gamma lookup tables.

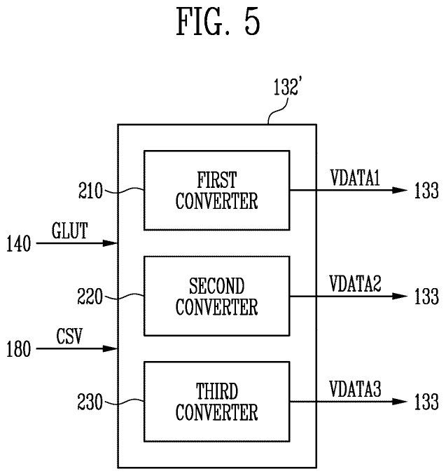

FIG. 5 is a block diagram illustrating an embodiment of the data converter 132′ of FIG. 4. Referring to FIG. 5, the data converter 132′ may include a first converter 210, a second converter 220, and a third converter 230. The data converter 132′ may receive the gamma lookup table GLUT and the sensing current value CSV. The first converter 210 may generate a first voltage value VDATA1 and transmit the first voltage value VDATA1 to the data driver 133. The second converter 220 may generate a second voltage value VDATA2 and transmit the second voltage value VDATA2 to the data driver 133. The third converter 230 may generate a third voltage value VDATA3 and transmit the third voltage value VDATA3 to the data driver 133.

In an embodiment, the first converter 210 may correspond to red data, the second converter 220 may correspond to green data, and the third converter 230 may correspond to blue data. In addition, the first voltage value VDATA1 may correspond to the red data, the second voltage value VDATA2 may correspond to the green data, and the third voltage value VDATA3 may correspond to the blue data.

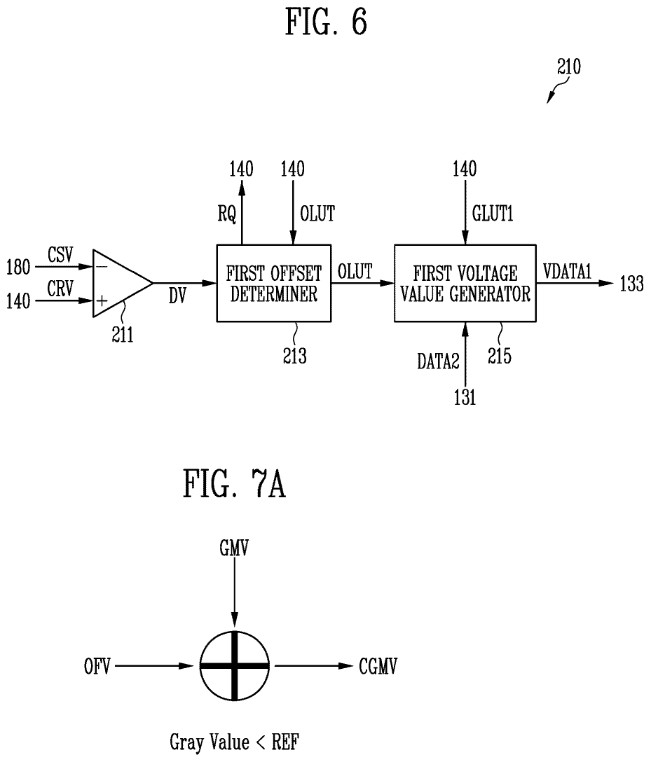

The first to third converters 210, 220, and 230 may compare the sensing current value CSV with the reference current value CRV and adjust the corresponding first to third gamma lookup tables GLUT1, GLUT2, and GLUT3, respectively. An embodiment of the first converter 210 among the first to third converters 210, 220, and 230 is described with reference to FIG. 6.

FIG. 6 is a block diagram illustrating an embodiment of the first converter 210 shown in FIG. 5. Referring to FIG. 6, the first converter 210 may include a comparator 211, a first offset determiner 213, and a first voltage value generator 215. As described above, the first converter 210 may correspond to the red data.

The comparator 211 may compare the sensing current value CSV with the reference current value CRV and output a difference value DV. The difference value DV may be transmitted to the first offset determiner 213.

The first offset determiner 213 may transmit a request RQ of an offset lookup table OLUT corresponding to the difference value DV to the memory 140. The memory 140 may transmit the offset lookup table OLUT corresponding to the received request RQ to the first offset determiner 213.

The memory 140 may store a plurality of offset lookup tables OLUT. For example, the memory 140 may store k offset lookup tables OLUT1 to OLUTk corresponding to red. The first offset determiner 213 may transmit the request RQ for the offset lookup table corresponding to the difference value DV to the memory 140.

For example, the first offset determiner 213 may determine the offset lookup table according to the difference value DV as shown in Table 1 below.

TABLE 1

| Range of difference value DV | Determined offset lookup table OLUT |
|---|---|
| DV > V1 | OLUT1 |
| V2 < DV ≤ V1 | OLUT2 |
| . . . | . . . |
| V(k-1) < DV ≤ V(k-2) | OLUT(k-1) |
| DV ≤ V(k-1) | OLUTk |

The memory 140 may provide the offset lookup table OLUT corresponding to the request RQ received from the first offset determiner 213 to the first offset determiner 213. The first offset determiner 213 transmits the received offset lookup table OLUT to the first voltage value generator 215.

For example, when the difference value DV output by the comparator 211 is a value between a first value V1 and a second value V2, the offset lookup table OLUT2 may be transmitted to the first offset determiner 213. An embodiment of the offset lookup table OLUT2 is shown in Table 2 below.

TABLE 2

| Gray (Red) | Offset value |
|---|---|
| 51~255 | 0 |
| 35~50 | ΔG5 |
| 25~34 | ΔG4 |
| 23~24 | ΔG3 |
| 12~22 | ΔG2 |
| 0~11 | ΔG1 |

Referring to [Table 2], an example of an offset lookup table having a single value for each section is shown. However, the disclosure is not limited thereto, an offset lookup table may have offset values which linearly increases or decreases in each section.

The offset lookup table may be configured in various methods. In addition, in [Table 2],each of offset values ΔG1 to ΔG5 may have a positive value or a negative value. In [Table 2], an offset value is 0 with respect to red grayscale values of 51 or higher. As described above with reference to FIGS. 3A to 3D, regardless of the color of the image displayed by the display unit 110, when the grayscale value is large, the luminance difference according to the temperature change decrease. In particular, when the grayscale is 51 or higher, the luminance difference according to the temperature change becomes small enough to be ignored. Therefore, in the offset lookup table according to the example of [Table 2], an offset of 0 may be applied when a red grayscale is 51 or higher. However, this is an example, and an offset other than 0 may also be applied to the red grayscale of 51 or higher.

The first voltage value generator 215 receives the offset lookup table OLUT, the first gamma lookup table GLUT1, and the image data DATA2. The first gamma lookup table GLUT1 may be a gamma lookup table corresponding to red. The first voltage value generator 215 adjusts values included in the first gamma lookup table GLUT1 based on the offset lookup table OLUT.

For example, the first gamma lookup table GLUT1 corresponding to red may include an entry corresponding to R0 to R255. The first voltage value generator 215 may add offset values included in the offset lookup table OLUT to each of 256 entries of the first gamma lookup table GLUT1.

For example, when using the offset lookup table of [Table 2], the offset value ΔG1 may be added to a voltage value corresponding to R0 to R11 among the entries included in the first gamma lookup table GLUT1. In addition, the offset value ΔG2 may be added to a voltage value corresponding to R12 to R22 among the entries included in the first gamma lookup table GLUT1. In such a method, a corresponding offset value may be added in a voltage value range corresponding to R50. Meanwhile, an offset value of 0 may be applied to the red grayscale of R51 or higher.

The first voltage value generator 215 generates the first voltage value VDATA1 from the image data DATA2 by using the first gamma lookup table corrected in the method described above. The first voltage value VDATA1 may be transmitted to the data driver 133.

In FIG. 6, a configuration and an operation of the first converter 210 are described. Meanwhile, the second converter 220 and the third converter 230 may have a configuration similar to that of the first converter 210 and may operate in a method similar to that of the first converter 210. Therefore, an overlap description of the second converter 220 and the third converter 230 is omitted.

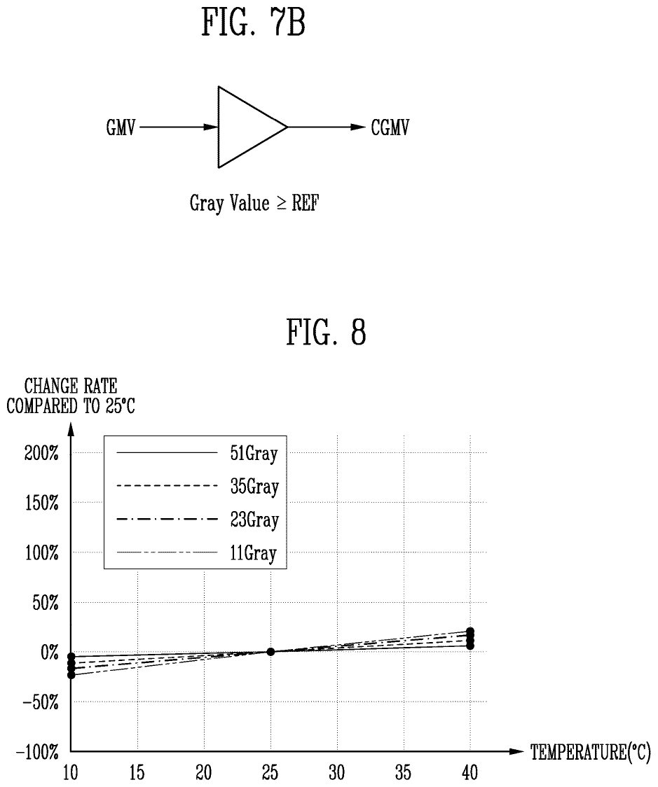

FIGS. 7A and 7B are diagrams illustrating a method of correcting the first gamma lookup table GLUT1 by the first voltage value generator shown in FIG. 6. Specifically, FIG. 7A shows a method of correcting a corresponding entry value when a gray value of the first gamma lookup table GLUT1 is less than a reference value, and FIG. 7B shows a method of correcting the corresponding entry value when the gray value of the first gamma lookup table GLUT1 is greater than or equal to the reference value REF.

Referring to FIG. 7A, when the gray value of the first gamma lookup table GLUT1 is less than the reference value, an offset value OFV and a gamma value GMV are added to generate a compensated gamma value CGMV. The offset value OFV of FIG. 7A may be an entry of which a gray value is less than the reference value among the entry values included in Table 2. For example, when the gray value is 33, the offset value OFV may be ΔG4. In this example, the gamma value GMV of FIG. 7A may be a gamma voltage value corresponding to the gray value of 33 among the entries of the first gamma lookup table.

Referring to FIG. 7B, when the gray value of the first gamma lookup table GLUT1 is greater than or equal to the reference value REF, the gamma value GMV is output as the compensated gamma value CGMV. In an example of [Table 2], the reference value REF may be 51. In this case, since the offset value becomes 0, the gamma value GMV is not corrected.

FIG. 8 is a graph illustrating the luminance change rate for each temperature of the white light when the display device 101 according to the embodiment of FIG. 4 displays the image. Specifically, FIG. 8 is a graph illustrating the luminance change rate of the white light for each of four grayscale data according to the temperature change.

When the display unit 110 of the display device 101 displays white image data corresponding to 11 Gray, the luminance of the display unit 110 decreases by 20% at 10° C. and increases by 20% at 40° C. as compared to the luminance at 25° C.

When the display unit 110 of the display device 101 displays white image data corresponding to 23 Gray, the luminance of the display unit 110 decreases by 15% at 10° C. and increases by 15% at 40° C. as compared to the luminance at 25° C.

When the display unit 110 of the display device 101 displays white image data corresponding to 35 Gray, the luminance of the display unit 110 decreases by 10% at 10° C. and increases by 10% at 40° C. as compared to the luminance at 25° C.

When the display unit 110 of the display device 101 displays white image data corresponding to 51 Gray, the luminance of the display unit 110 decreases by 5% at 10° C. and increases by 5% at 40° C. as compared to the luminance at 25° C.

Referring to FIGS. 3A and 8, it may be seen that the luminance change according to the temperature for each grayscale is significantly decreased in the graph of FIG. 8 compared to FIG. 3A. Therefore, according to the display device 101 according to an embodiment of the disclosure, the luminance change according to the temperature change may be minimized at a low grayscale.

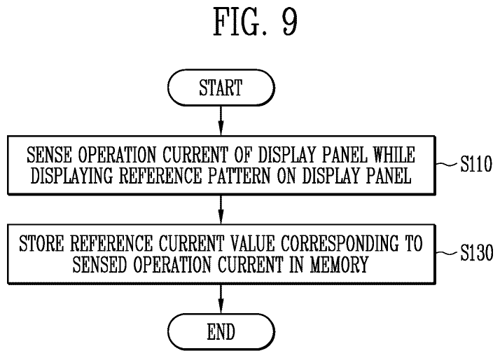

FIG. 9 is a flowchart illustrating a method of operating a display device according to an embodiment of the disclosure.

Referring to FIG. 9, the method of operating the display device includes sensing an operation current of the display panel while displaying a reference pattern on the display panel (S110) and storing a reference current value corresponding to the sensed operation current in a memory (S130).

In an embodiment, step S110 may be performed in a test step before the display device 101 is shipped. Step S110 may be performed on a reference environment. That is, step S110 may be performed under a reference temperature and a reference illuminance. For example, the reference temperature may be 25° C. and the reference illuminance may be 5001× which is a general indoor illuminance. In addition, while displaying the reference pattern on the display panel, the current sensor 180 may sense the current flowing in the display unit 110 through the terminal or the line to which the second power voltage ELVSS is supplied. A sensing result may be determined as the reference current value and may be stored in the memory 140.

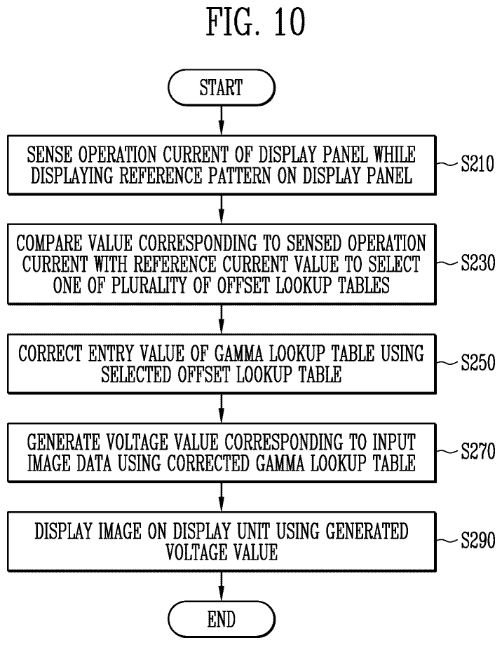

FIG. 10 is a flowchart illustrating a method of operating a display device according to an embodiment of the disclosure.

Referring to FIG. 10, the method of operating the display device includes sensing an operation current of a display panel while displaying a reference pattern on the display panel (S210), comparing a value corresponding to the sensed operation current with a reference current value to select one of a plurality of offset lookup tables (S230), correcting an entry value of a gamma lookup table using the selected offset lookup table S250, using the corrected gamma lookup table (S250), generating a voltage value corresponding to input image data (S270), and displaying an image on a display unit using the generated voltage value (S290).

In an embodiment, step S210 may be performed during an operation of the display device 101. The reference pattern displayed by the display panel during step S210 may be the same as the reference pattern displayed in step S110 of FIG. 9. While the reference pattern is displayed on the display panel, the power supply 160 of FIG. 4 may supply driving voltages, for example, the first power voltage ELVDD, the second power voltage ELVSS, and the initialization voltage Vint to the display unit 110, that is, the display panel.

Meanwhile, in step S230, the data converter 132′ may select one of the plurality of offset lookup tables OLUT stored in the memory 140 based on a difference between the sensing current value CSV and the reference current value CRV.

Specifically, step S230 may include selecting an offset lookup table corresponding to red, selecting an offset lookup table corresponding to green, and selecting an offset lookup table corresponding to blue. That is, the corresponding offset lookup table may be different according to each color.

In step S250, each of the entry values included in the gamma lookup table may be corrected using the selected offset lookup table as described with reference to FIG. 6. A gamma value corresponding to a gray value greater than or equal to the reference value REF may not be corrected.

Meanwhile, step S250 may include correcting the gamma lookup table corresponding to red, correcting the gamma lookup table corresponding to green, and correcting the gamma lookup table corresponding to blue. As described above, since the offset lookup table corresponding to red, green, and blue is individually selected in step S230, the offset lookup tables respectively corresponding to red, green, and blue may be applied to the gamma lookup tables corresponding to red, green, and blue, respectively, to correct the gamma lookup tables corresponding to red, green, and blue, respectively.

In step S270, the voltage value VDATA corresponding to the image data DATA2 is generated using the corrected gamma lookup table. The voltage value VDATA may be transmitted to the data driver 133, and the data driver 133 may display the received voltage value VDATA on the display unit 110 (S290).

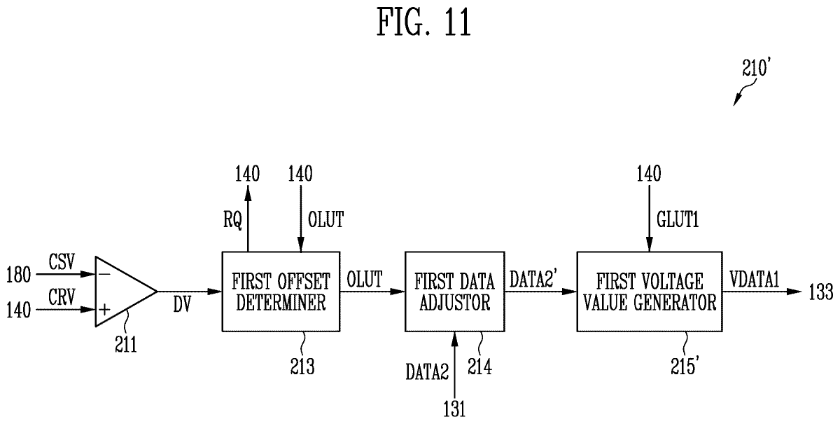

FIG. 11 is a block diagram illustrating an embodiment of the first converter shown in FIG. 5. Referring to FIG. 11, the first converter 210′ includes the comparator 211, the first offset determiner 213, a first data adjuster 131, and a first voltage value generator 215′. As described above with reference to FIG. 5, the first converter 210′ may correspond to the red data.

The comparator 211 may compare the sensing current value CSV with the reference current value CRV and output the difference value DV. The difference value DV may be transmitted to the first offset determiner 213.

The first offset determiner 213 may transmit a request RQ of the offset lookup table OLUT corresponding to the difference value DV to the memory 140. The memory 140 may transmit the offset lookup table OLUT corresponding to the received request RQ to the first offset determiner 213.

The memory 140 may store a plurality of offset lookup tables OLUT. For example, the memory 140 may store k offset lookup tables OLUT1 to OLUTk corresponding to red. The first offset determiner 213 may transmit the request RQ for the offset lookup table corresponding to the difference value DV to the memory 140.

For example, the first offset determiner 213 may determine an offset lookup table according to the difference value DV as shown in Table 1 described above.

The offset lookup table used in the embodiment of FIG. 6 includes offset values applied to each entry of the gamma lookup table GLUT1. On the other hand, the offset lookup table used in the embodiment of FIG. 11 may include offset values used to adjust a data value of the image data DATA2.

As described above, the memory 140 may provide the offset lookup table OLUT corresponding to the request RQ received from the first offset determiner 213 to the first offset determiner 213. The first offset determiner 213 transmits the received offset lookup table OLUT′ to the first voltage value generator 215. For example, when the difference value DV output by the comparator 211 is a value between the first value V1 and the second value V2, the offset lookup table OLUT2 as described with reference to [Table 1] may be transmitted to the first offset determiner 213. In the embodiment of FIG. 11, an embodiment of the offset lookup table OLUT2 is shown in Table 3 below.

TABLE 3

| Gray (Red) | Offset value |
|---|---|
| 51~255 | 0 |
| 35~50 | ΔD5 |
| 25~34 | ΔD4 |
| 23~24 | ΔD3 |
| 12~22 | ΔD2 |
| 0~11 | ΔD1 |

Referring to [Table 3], an example of an offset lookup table having a single value for each section is shown. However, the disclosure is not limited thereto, an offset lookup table may have the offset values which linearly increases or decreases in each section. The offset lookup table may be configured in various methods. In addition, in [Table 3], each of offset values ΔD1 to ΔD5 may have a positive value or a negative value.

In [Table 3], the offset value is 0 with respect to red grayscale values of 51 or higher. As described above with reference to FIGS. 3A to 3D, regardless of the color of the image displayed by the display unit 110, when the grayscale value is large, the luminance difference according to the temperature change decreases. In particular, when the grayscale is 51 or higher, the luminance difference according to the temperature change becomes small enough to be ignored. Therefore, in the offset lookup table according to the example of [Table 3], an offset of 0 may be applied when the red grayscale is 51 or higher. However, this is an example, and an offset other than 0 may also be applied to the red grayscale of 51 or higher.

The first data adjuster 214 receives the offset lookup table OLUT and the image data DATA2. The first data adjuster 214 and the first voltage value generator 215′ adjust the image data DATA2 based on the offset lookup table OLUT. For example, the image data DATA2 corresponding to red may include data corresponding to one of R0 to R255. The first data adjuster 214 adds the offset value corresponding to the image data DATA2 to the image data DATA2 by referring to the offset lookup table OLUT. Thereafter, an added result is output as adjusted image data DATA2′.

For example, when a value of the received image data DATA2 is R23, the adjusted image data DATA2′ output from the data adjuster 214 may have a value of “R23+ΔD3”.

The first voltage value generator 215′ receives the first gamma lookup table GLUT1 and the adjusted image data DATA2′. The first gamma lookup table GLUT1 may be the gamma lookup table corresponding to red. The first voltage value generator 215′ generates the first voltage value VDATA1 from the adjusted image data DATA2′ by using the first gamma lookup table. The first voltage value VDATA1 may be transmitted to the data driver 133.

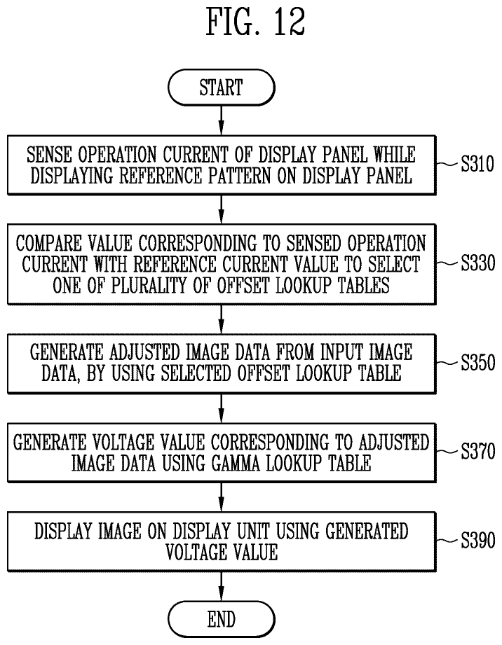

FIG. 12 is a flowchart illustrating a method of operating a display device according to embodiment of the disclosure.

Referring to FIG. 12, the method of operating the display device includes sensing an operation current of a display panel while displaying a reference pattern on the display panel (S310), comparing a value corresponding to the sensed operation current with a reference current value to select one of a plurality of offset lookup tables (S330), generating adjusted image data from input image data using the selected offset lookup table (S350), generating a voltage value corresponding to the adjusted image data by using a gamma lookup table (S370), and displaying an image on a display unit using the generated voltage value (S390).

Similarly to step S210 of FIG. 10, step S310 of FIG. 12 may be performed during an operation of the display device 101. Meanwhile, in step S330, the data converter 132′ may select one of the plurality of offset lookup tables OLUT stored in the memory 140 based on a difference between the sensing current value CSV and the reference current value CRV.

Specifically, step S330 may include selecting the offset lookup table corresponding to red, selecting the offset lookup table corresponding to green, and selecting the offset lookup table corresponding to blue. That is, a corresponding offset lookup table may be different for each color.

In step S350, the adjusted image data DATA2′ may be generated by adjusting the value of the image data DATA2 by using the selected offset lookup table as described with reference to FIG. 11. The image data DATA2 corresponding to a gray value greater than or equal to the reference value REF may not be adjusted.

Meanwhile, step S350 may include adjusting image data corresponding to red, adjusting image data corresponding to green, and adjusting image data corresponding to blue. As described above, since the offset lookup tables respectively corresponding to red, green, and blue are individually selected in step S330, adjusted image data respectively corresponding to red, green, and blue may be generated by respectively applying offset lookup tables respectively corresponding to red, green, and blue to image data corresponding to red, green, and blue in step S350.

In step S370, the voltage value VDATA1 corresponding to the adjusted image data DATA2′ is generated by using the gamma lookup table GLUT1 stored in the memory. The voltage value VDATA1 may be transmitted to the data driver 133, and the data driver 133 may display the received voltage value VDATA on the display unit 110 (S390).

Although the technical spirit of the disclosure has been described in detail in accordance with the above-described embodiments, it should be noted that the above-described embodiments are for the purpose of description and not of limitation. In addition, those skilled in the art may understand that various modifications are possible within the scope of the technical spirit of the disclosure.

What is claimed is:

1. A display device comprising:
a display unit including a plurality of pixels;
a power supply configured to generate a plurality of driving voltages;
a current sensor configured to sense a current amount output from the power supply to the display unit while reference image data is displayed on the display unit and generate a sensing current value corresponding to a sensing result; and
a driver configured to generate a data signal and transmit the data signal to a corresponding pixel,
wherein the driver generates the data signal by applying an offset determined for each grayscale of image data input based on the sensing current value.

2. The display device according to claim 1, further comprising:
a memory configured to store a reference current value, a plurality of offset lookup tables, and a gamma lookup table,
wherein the reference current value corresponds to the current amount output from the power supply to the display unit while reference image data determined in advance at a reference temperature is displayed on the display unit, and
wherein the driver compares the reference current value and the sensing current value, selects one of the plurality of offset lookup tables based on a comparison result, and corrects the gamma lookup table using the selected offset lookup table.

3. The display device according to claim 2, wherein the driver comprises:
a controller configured to convert input image data to generate image data;
a data converter configured to receive the sensing current value, the reference current value, the image data, and the gamma lookup table, and generate a voltage value corresponding to the image data; and
a data driver connected to the pixel through a data line, and configured to generate the data signal corresponding to the voltage value and supply the generated data signal to the data line.

4. The display device according to claim 3, wherein the data converter comprises:
a first converter corresponding to red;
a second converter corresponding to green; and
a third converter corresponding to blue, and
wherein the gamma lookup table includes at least one of a first gamma lookup table corresponding to red, a second gamma lookup table corresponding to green, and a third gamma lookup table corresponding to blue.

5. The display device according to claim 4, wherein the first converter comprises:
a comparator configured to receive the reference current value and the sensing current value and output a difference value corresponding to a difference between the reference current value and the sensing current value;
a first offset determiner configured to receive an offset lookup table corresponding to the difference value from the memory; and
a first voltage value generator configured to receive the first gamma lookup table, correct at least one entry value included in the first gamma lookup table based on the offset lookup table, generate a corrected first gamma lookup table, and generate a voltage value corresponding to the image data using the corrected first gamma lookup table.

6. The display device according to claim 5, wherein the first voltage value generator corrects an entry value of which a gray value is less than a reference value using the offset lookup table among entry values included in the first gamma lookup table, and maintains an entry value of which the gray value is greater than or equal to the reference value among the entry values included in the first gamma lookup table.

7. The display device according to claim 4, wherein the first converter comprises:
a comparator configured to receive the reference current value and the sensing current value and output a difference value corresponding to a difference between the reference current value and the sensing current value;
a first offset determiner configured to receive an offset lookup table corresponding to the difference value from the memory;
a first data adjuster configured to generate adjusted image data by adjusting a value of the image data based on the offset lookup table; and
a first voltage value generator configured to generate a voltage value corresponding to the adjusted image data using the first gamma lookup table.

8. The display device according to claim 7, wherein the first data adjuster corrects a value of the image data using the offset lookup table when the value of the image data is less than a reference value, and maintains the value of the image data when the value of the image data is greater than or equal to the reference value.

9. The display device according to claim 1, further comprising:
a temperature sensor configured to sense a temperature and generate a power control signal corresponding to the sensed temperature,
wherein the power supply changes a voltage level of the driving voltage based on the power control signal.

10. The display device according to claim 1, further comprising:
an illuminance sensor configured to sense an illuminance and generate a power control signal corresponding to the sensed illuminance,
wherein the power supply changes a voltage level of the driving voltage based on the power control signal.

11. A method of operating a display device, the method comprising:
sensing an operation current of a display panel while displaying a reference pattern on the display panel;
comparing the sensed operation current with a predetermined reference current value;
selecting one of a plurality of offset lookup tables according to the comparing result;
correcting a gamma lookup table using the selected offset lookup table; and
generating a voltage value corresponding to image data using the corrected gamma lookup table.

12. The method according to claim 11, wherein the selecting one of the plurality of offset lookup tables comprises:
selecting a first offset lookup table corresponding to red;
selecting a second offset lookup table corresponding to green; and
selecting a third offset lookup table corresponding to blue.

13. The method according to claim 12, wherein the correcting the gamma lookup table comprises:
correcting a first gamma lookup table corresponding to red using the first offset lookup table;
correcting a second gamma lookup table corresponding to green using the second offset lookup table; and
correcting a third gamma lookup table corresponding to blue using the third offset lookup table.

14. The method according to claim 13, wherein, when correcting the first gamma lookup table corresponding to red, an entry of which a gray value is less than a predetermined reference value among entries of the first gamma lookup table is corrected using an offset value included in the first offset lookup table, and an entry of which the gray value is greater than or equal to the reference value among the entries of the first gamma lookup table is maintained.

15. The method according to claim 11, further comprising, after generating the voltage value corresponding to the image data:
displaying an image on the display panel using the generated voltage value.

16. The method according to claim 11, further comprising before sensing the operation current of the display panel while displaying the reference pattern on the display panel:
sensing the operation current of the display panel while displaying the reference pattern on the display panel under a reference environment; and
storing a reference current value corresponding to the sensed operation current in a memory.

17. A method of operating a display device, the method comprising:
sensing an operation current of a display panel while displaying a reference pattern on the display panel;
comparing the sensed operation current with a predetermined reference current value;
selecting one of a plurality of offset lookup tables according to the comparing result;
generating adjusted image data from image data using the selected offset lookup table; and
generating a voltage value corresponding to the adjusted image data using a gamma lookup table.

18. The method according to claim 17, wherein the selecting one of the plurality of offset lookup tables comprises:
selecting a first offset lookup table corresponding to red;
selecting a second offset lookup table corresponding to green; and
selecting a third offset lookup table corresponding to blue.

19. The method according to claim 18, wherein the generating adjusted image data from the image data comprises:
adjusting first image data corresponding to red using the first offset lookup table;
adjusting image data corresponding to green using the second offset lookup table; and
adjusting third image data corresponding to blue using the third offset lookup table.

20. The method according to claim 19, wherein, when adjusting the first image data corresponding to red, a value of the first image data is adjusted using an offset value included in the first offset lookup table when the value of the first image data is less than a predetermined reference value, and the value of the first image data is maintained when the value of the first image data is greater than or equal to the predetermined reference value.
